(19) United States
(12) Patent Application Publication
(10) Pub. No.: US 2008/0135772 A1
(43) Pub. Date: Jun. 12, 2008

(54) METHOD AND SYSTEM FOR SPECIAL NUCLEAR MATERIAL DETECTION

(75) Inventors: Bernhard Erich Hermann Claus, Niskayuna, NY (US); Jeffrey Wayne Eberhard, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/608,095

(22) Filed: Dec. 7, 2006

(51) Int. Cl. G01V 5/00

(52) U.S. Cl. 250/390.01

(57) ABSTRACT

A method of analyzing a container for presence of special nuclear materials (SNM) is disclosed. The method includes obtaining information regarding at least one of the container and contents therein, automatically selecting an operational parameter in response to the information; and, performing a screening of the container according to the selected operational parameter. The screening includes irradiating the container with an energetic beam comprising at least one of fast neutrons and high-energy photons; detecting energy emitted in response to the irradiating; and analyzing the detected energy for a presence of SNM.

### FEDERAL RESEARCH STATEMENT

This invention was made with Government support under contract N66001-05-D-6033 awarded by the Department of Homeland Security. The Government has certain rights in this invention.

### BACKGROUND OF THE INVENTION

The present disclosure relates generally to material detection, and particularly to detection of special nuclear material in cargo.

The modern global economy relies heavily on intermodal shipping containers for rapid, efficient transport of ocean-going cargo. However, the possibility of concealing weapons of mass destruction (WMDs) and radiological dispersal devices (RDDs) in these containers represents a potential interruption to the free flow of commerce.

Special nuclear material (SNM) is defined by Title I of the Atomic Energy Act of 1954 as plutonium, uranium-233, or uranium enriched in the isotopes uranium-233 or uranium-235. The definition includes any other material that the Nuclear Regulatory Commission (NRC) determines to be special nuclear material. The definition does not include source material. The NRC has not declared any other material as SNM. SNM is only mildly radioactive, but it includes some fissile material, uranium-233, uranium-235, and plutonium-239, that, in concentrated form, can be the primary ingredients of nuclear explosives. These materials, in quantities greater than formula quantities, are defined as “strategic special nuclear material” (SSNM). The uranium-235 content of low-enriched uranium can be concentrated, that is enriched, to make highly enriched uranium, the primary ingredient of a nuclear weapon.

A variety of non-intrusive inspection (NII) systems have been proposed to detect SNM-containing devices, including radiation portal monitors, radiography systems, and active screening systems. Passive radiation portal monitors may be impractical in cases where the SNM is hidden in large sea-going cargo containers. Such containers may be filled with materials having a mass approaching 27 Metric Tons (MT) through which an identifying signal must penetrate to reach a detector. Traditional methods of radiography are unlikely to provide a unique signature of highly enriched uranium-235 and plutonium239. Active interrogation with neutrons or high-energy photons in a variety of forms currently depends upon the observation of beta-delayed neutrons or gamma rays following induced fission to provide a unique signature for uranium-235 and plutonium-239. However, in their simplest form, such methods may be inadequate to satisfactorily respond to the variety of condition parameters, including presence of interferents and attempts to shield the SNM within the cargo container.

Accordingly, there is a need in the art for a SNM detection arrangement that overcomes one or more of these drawbacks.

### SUMMARY

An embodiment of the invention includes a method of analyzing a container for presence of special nuclear materials (SNM). The method includes obtaining information regarding at least one of the container and contents therein, automatically selecting an operational parameter in response to the information, and, performing a screening of the container according to the selected operational parameter. The screening includes irradiating the container with an energetic beam comprising at least one of fast neutrons and high-energy photons, detecting energy emitted in response to the irradiating, and, analyzing the detected energy for a presence of SNM.

Another embodiment of the invention includes a system for analyzing a presence of special nuclear materials (SMN) within a container. The system includes a processor, an energy source in signal communication with and responsive to the processor to emit at least one of fast neutrons and high-energy photons, and a set of energy detectors in signal communication and responsive to the processor to detect energy emitted in response to the emission of the at least one of fast neutrons and high-energy photons. The processor is responsive to information regarding at least one of the container and contents therein to automatically select a screening operational parameter and to analyze energy detected by the set of energy detectors in response to an irradiation of the container by the energy source for a presence of SNM.

These and other advantages and features will be more readily understood from the following detailed description of preferred embodiments of the invention that is provided in connection with the accompanying drawings.

### BRIEF DESCRIPTION OF THE DRAWINGS

FIG. 1 depicts a SNM detection system in accordance with an embodiment of the invention.

FIG. 2 depicts a chart of a modeled spectral response of a SNM and an interferent to irradiation in accordance with an embodiment of the invention.

FIG. 3 depicts a chart of a detected spectral response of a SNM and an interferent to irradiation in accordance with an embodiment of the invention.

FIG. 4 depicts a chart of a time response of a SNM and an interferent to irradiation in accordance with an embodiment of the invention.

FIG. 5 depicts a flowchart of a method to detect SNM in a cargo container in accordance with an embodiment of the invention.

### DETAILED DESCRIPTION OF EXEMPLARY EMBODIMENTS

An embodiment of the invention provides a method for evaluating a detected signal at a surface of a cargo container or other object of interest for a presence of SNM. The method includes measurement of a background signal in detectors before the cargo container is irradiated, and measurement of a signal in the detectors again in response to an irradiation pulse. In one embodiment, irradiation characteristics (e.g., timing) are adapted to a specific cargo container by means of available prior information. Signals are evaluated, and a presence of a signal that is significantly different from (e.g., higher number of counts than) the background signal indicates that suspicious material may be present in the cargo container. In some embodiments, subsequent irradiation sequences are carried out and the signal is analyzed in more detail to gain additional information about the contents of the container. These additional sequences can also be modified in accordance with the signal responsive to a first, or an initial irradiation sequence.

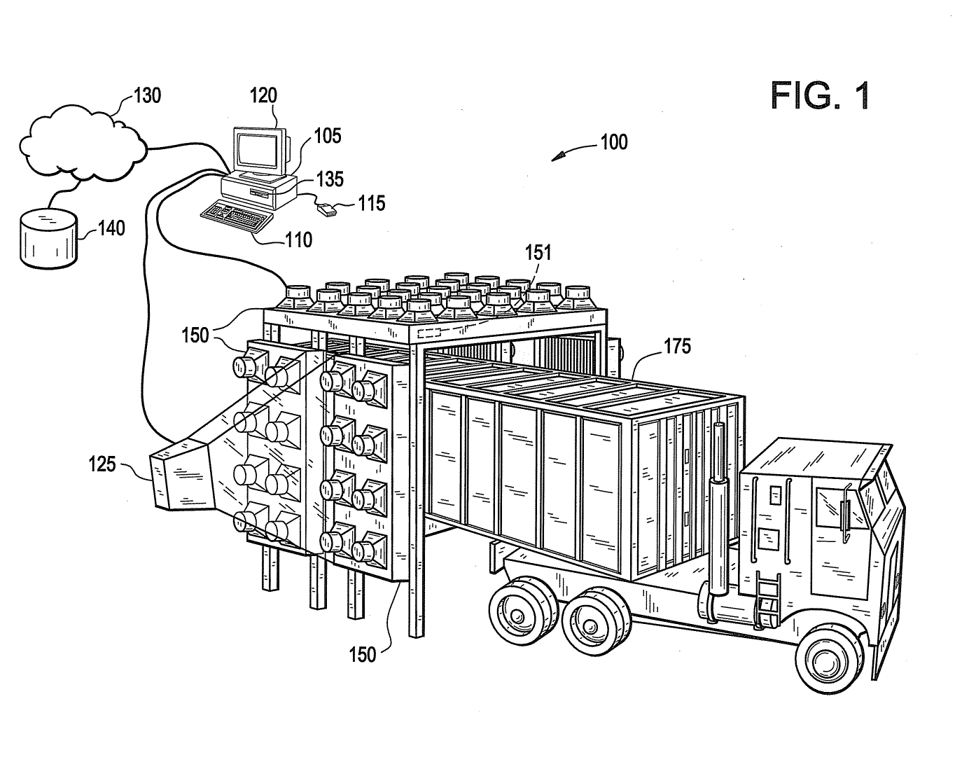

Referring now to FIG. 1, an embodiment of a SNM detection system 100 is depicted. The SNM detection system 100 includes an energy source 125, a set of signal detector modules 150, also herein referred to as detectors, and a target cargo container 175 to be evaluated. In an embodiment, the energy source 125 includes a fan beam neutron source. In another embodiment, the energy source 125 includes a high-energy photon (e.g., x-ray) source.

The SNM detection system 100 also includes a processor 105 in signal communication with the energy source 125 and the set of signal detector modules 150. In an embodiment, the processor 105 is a general-purpose computer. The processor 105 includes input devices 110, 115, such as a keyboard and a mouse, respectively, an output device 120, such as a display screen, and a program storage device 135, such as a hard disk drive, for example. In an embodiment, the processor 105 is in signal communication with a network 130, such as an intranet or the Internet, for example, and a database 140 that may contain a history of inspection results and other information associated with the cargo container 175, for example.

While an embodiment has been depicted in wired signal communication via a network between the processor 105 and the database 140, it will be appreciated that the scope of the embodiment is not so limited, and that the embodiment will also apply to SNM detection systems that may be in signal communication with one or more processors 140 via a wireless network connection, for example.

In an embodiment, the energy source 125 irradiates the cargo container 175 with fast neutrons that have an energy level less than 9 Mega electron Volts (MeV). It will be appreciated by one skilled in the art that irradiation of SNM by neutrons results in a release of fission fragments and delayed neutrons and delayed gamma rays. Radiation energy from the decaying fission fragments, neutrons, and gamma rays is received, or detected by the detectors 150 surrounding the cargo container 175. The detectors 150 convert the detected energy, also herein referred to as a detected signal to at least one of an analog and a digital electrical signal, and make available to the processor 105 the electrical signal for analysis.

The half-life of fission products resulting from irradiation of SNM includes a combination of components with different half-lives ranging from less than 1 second to more than 30 seconds, with an average measured half-life that is often less than twenty seconds. Because few known backgrounds (with the exception of substances known as interferents, to be described further below) include the release of high-energy gamma rays at a level greater than 3 MeV in response to such irradiation, presence of such rays provides a high degree of certainty of the presence of SNM within the cargo container 175. In an embodiment, discrimination algorithms will separate gamma rays due to interferents from gamma rays due to SNM.

Detection of delayed neutrons will provide an additional response signature that is particularly useful in metallic cargos. In hydrogenous cargo, such as wood, the delayed neutrons are strongly attenuated, and may not be able to be detected. In this case only the delayed gamma rays may be used. In metallic cargos, the delayed neutrons are less attenuated, and can provide additional data that is useful. Detection of delayed neutrons can be useful, because most common interferents have relatively low atomic number as compared to that of SNM, and the response to active screening irradiation generally includes only delayed gammas, and not delayed neutrons. Accordingly, detection of delayed neutrons subsequent to the irradiation is a very strong indicator of the presence of SNMs within the cargo container 175.

In another embodiment, the energy source 125 irradiates the cargo container 175 with high-energy photons, such as x-rays, also known as photofission. Photofission provides a complementary interrogation medium that can have improved penetration of hydrogenous cargos. Photofission of SNM has a response signature that is similar to that of fast neutrons, including delayed neutrons and delayed gamma rays from fission fragments. In another embodiment, at least one energy source 125 will irradiate the cargo container 175 with high-energy photons and fast neutrons. It will be appreciated that in an embodiment the high energy photons and the fast neutrons may be supplied by separate energy sources 125. Note that different irradiation sequences may use different “modalities”, such as at least one of neutrons and photons for irradiation of the cargo container 175.

In one embodiment, each detector module 150 includes a processor 151. The processor 151 extracts information from characteristics of detected energy, and makes available to the processor 105 the electrical signal that includes only the extracted information. In some embodiments, only a total of counts of energy detected by the detector 150 within a defined time interval, such as between 0.1 to 30 seconds subsequent to the end of the irradiation and within a defined energy range, such as above 3 MeV, are extracted from the detected energy signal and made available to the processor 105. In other embodiments, characteristics of the detected energy signal made available to the processor 105 are varied, including counts detected within one or more tine intervals, such as between 0.1 to 1.1 seconds, 1.1 to 2.1 seconds, and so forth. Other variations of characteristics of the detected signal includes energy counts detected within one or more energy ranges, such as between 3.0 to 3.5 MeV, 3.5 to 4.0 MeV, and so forth, and one-dimensional and multi-dimensional features that can be extracted from the raw detected energy signal. In an embodiment, a raw (non-processed) electrical signal is made available to the processor 105.

For cargos having neither interferents nor SNM, irradiation with fast neutrons or high-energy photons does not produce radiation subsequent to the energy source 125 being turned off. Therefore, the presence of the detected signal above the background subsequent to the turning off of the energy source 125 can be indicative of the presence of SNM within the cargo container 175. The characteristic signature of SNM, in response to irradiation, includes delayed gamma rays and delayed neutrons over a wide energy range of approximately 0 to 10 MeV. Some naturally occurring radioactive material can emit gamma rays with energies up to 2.6 MeV. Accordingly, the presence of delayed gamma rays with energies above 3 MeV is a strong indicator of SNM. In an embodiment, the detected signal is compared to background, and if the signal is larger than background, the container is deemed suspicious, and further analysis is performed. Evaluation of data collected as part of an initial irradiation sequence may also employ more complex analysis approaches. Further analysis of the data may then be adapted, based on a result of the initial sequence.

In an embodiment, a set of detectors 150 will include multiple detectors over a large area to increase an overall signal level in the SNM detection system 100. A set of at least one of digital and analog electrical signals, in response to the irradiation by the energy source 125 and the background prior to irradiation, generated by the set of detectors 150 are appropriately combined among the multiple detectors 150 to enhance detectability.

In an embodiment, multiple irradiation and detection sequences, or screenings, are used to improve detection accuracy. For example, an initial short irradiation followed by a short detection period will provide an initial screening to determine if a signal that is determined to be different from background is present in response to the initial short irradiation. If the signal is determined to correspond to “background only”, the cargo container 175 may be determined to be free of SNM and cleared without further analysis. If, however, a signal indicative of the possible presence of at least one of SNM and interferents in response to the initial screening is detected, additional screenings may be determined and employed to improve the accuracy of the detection. The additional irradiation sequences may be used to improve information content in the collected signals, such as improving a signal-to-noise ratio, and a penetration of the cargo, for example. In an embodiment, the additional irradiation sequences may be selected based on information about insufficient penetration from the initial screening sequence. In another embodiment, the processor 105 is responsive to information resulting from a primary inspection regarding at least one of the container and contents therein to automatically select an operational parameter of each screening. The processor 105 is also responsive to the information to analyze energy detected by the set of energy detectors 150 in response to the irradiation of the container 175 by the energy source 125 for the presence of SNM. An example of the primary inspection is a radiographic inspection that can be used to show the presence of heavy shielding materials.

Additional examples of information regarding at least one of the container 175 and contents therein provided by a variety of primary inspections include the result of inspection with portal monitors or handheld radiation monitors that detect the spontaneous decay of radioisotopes within the container, information provided on a shipping manifest, weight of the cargo container 175, identity of a company responsible for shipping the cargo container 175, and shipping origin of the cargo container 175, for example. Information provided on the shipping manifest may be relevant to determine expected traits of the cargo container 175, such as an expected weight or density based upon the disclosed contents, for example. Also, the cargo manifest may indicate the presence of hydrogenous cargo, which may result in selection of use of high-energy photons in the initial screening. Similarly, the shipping origin, as well as any intermediate destinations, may indicate an increased (or decreased) possibility of SNM within the cargo container 175. The information regarding the company responsible for shipping the cargo container 175 may, for example in conjunction with a history of previous inspection results for containers shipped by the same company, be relevant to determine companies that are expected to have a lesser or greater likelihood of shipping containers 175 including SNM. In an embodiment, the primary inspection includes the initial screening to provide information regarding regarding at least one of the container and contents therein.

In one embodiment the processor 105 is responsive to the primary inspection that includes a first detector signal, also herein referred to as an initial signal, subsequent to a first irradiation of the cargo container 175 by the energy source 125. In one embodiment, if the first detector signal is in excess of a first threshold value, such as the background signal for example, the processor 105 will automatically select, or adjust an operational parameter of a second irradiation, also herein referred to as a secondary screening. The processor 105 will then compare a second detector signal, subsequent to the second irradiation of the cargo container 175 with a second threshold value, such as an expected change in the second detector signal following the adjustment in the operational parameter, and the first detector signal to provide a determination if there is a presence of the SNM within the cargo container 175. It will be appreciated that the determination of the presence of SNM within the cargo container 175 can include more than two irradiation cycles. The irradiation cycles may use the same operational parameter settings (to improve only the signal-to-noise ratio), or they may use different operational parameter settings (including, but not limited to irradiation time, detection time, and irradiation modality, as will be discussed further below).

In an embodiment, different operational parameter settings can include a flux of the at least one energy source 125, such as a number of at least one of neutrons and photons generated per unit time, a location of the energy source 125 based upon information from the primary inspection, such as to leverage a “low-attenuation” path to a region of interest (ROI) in the container 175, a selection of a number of energy sources 125, a selection of energizing multiple energy sources 125 simultaneously, and a location of the set of detectors 150.

It will be appreciated that the use of multiple detectors 150 for a signal level that is not significantly above the background can reduce the signal-to-noise ratio if the total counts from multiple detectors 150 are used for detection. In an embodiment, a variable number of detectors 150 may be used for detection. The variable number of detectors to be used will be defined adaptively as the operational parameter in response to the first signal level that has been received in each detector 150 following the first irradiation of the cargo container 175. In another embodiment, it is contemplated that the variable number of detectors 150 to be used will be defined adaptively in response to other data, such as the result of the primary inspection, for example. An embodiment will include multiple detectors 150 of different types, such as neutron detectors, gamma ray detectors, and hybrid detectors that include a plastic scintillator for gamma rays with an embedded neutron sensor, for example. Different combinations and configurations of detectors 150 may be used. Even for a single “modality”, different detector 150 sizes and types may be used, corresponding to different energy resolution, and detector 150 efficiency, for example.

In an embodiment the adjusted operational parameter of the irradiation sequences includes a different timing, or irradiation duration, by the energy source 125, and detection duration, by the set of energy detectors 150. The different timing can be used to increase the level of incident radiation by increasing the irradiation time, improve definition of the temporal response of the signal by increasing the detection time, and decrease the background level by reducing the detection time. The different timing can be adaptively selected in response to, and based upon the initial signal detected. For example, it is contemplated that if the initial signal detected indicates a fast decay, it may be advantageous to utilize additional irradiation sequences that include short bursts of radiation followed by short reception periods. The different timing may also be selected adaptively as a function of information from the primary inspection.

In an embodiment, other operational parameters or characteristics of the additional irradiation sequences are also adaptive in response to analysis of the primary inspection. The energy source 125 is responsive to adjustment of the operational parameter of an energy level or amount of energy of irradiation, such as to avoid activating certain materials. In another embodiment, the energy source 125 is responsive to adjustment of the operational parameter of the modality of radiation, such as selection of and alternation between irradiating the cargo container 175 with fast neutrons and high-energy photons, for example.

In an additional embodiment, selection of the operational parameter includes a dual-energy approach. The dual-energy approach is similar to dual energy x-ray imaging. The dual-energy approach includes irradiating the cargo container 175 with neutron beams of different energies. The two corresponding detected signals are then analyzed using the varying relative activation rates of different materials with respect to the two known neutron energies. This can help, for example, to distinguish interferents from SNM, as will be described further below. As a further example, more than two energy levels can be employed. It will be appreciated that although higher energy levels provide increased penetration, higher energy levels are also more likely to activate interferents. Accordingly, use of an increased number of energy levels can provide an optimized balance between necessary penetration of the contents of the cargo container 175 and activation of interferent substances.

In an embodiment, the operational parameters include the mode of signal detection, selected adaptively in response to analysis of the primary inspection. For example, in response to receiving the initial signal indicating a likelihood of the presence of SNM, the processor will compare a set of characteristics from the detected signal to a set of characteristics from the expected signature from SNM to define a confidence level, and thereby statistically quantify the similarity of the detected signal to at least one contraband of interest. Further, the detection mode can be a multi-mode detection, such as the selection of and alternation between detecting delayed gamma rays and delayed neutrons, for example. In another embodiment, one or more of the detectors 150 disposed opposite the energy source 125 are used during the radiation transmission to estimate the amount of penetration and determine an appropriate transmission energy level.

In one embodiment, the detected signal subsequent to the transmission of radiation energy is compared to the first threshold, such as the background, and if the detected signal is larger than the first threshold, the cargo container 175 is deemed suspicious, and at least one of further irradiation and analysis is performed. In an embodiment, the further analysis includes a determination of whether materials known as “interferents” are present. Some materials, herein referred to as “interferents” can be excited by the incident radiation to emit delayed gammas with energies above 3 MeV. However, the energy spectrum emitted by such interferents is often limited to a few characteristic energies.

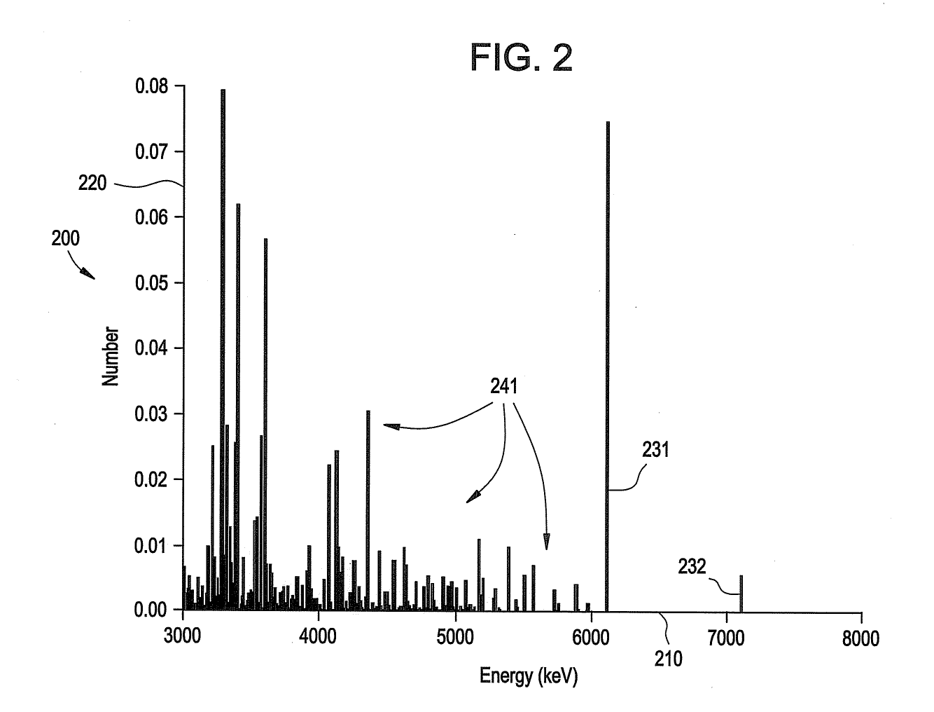

Referring now to FIG. 2, a chart 200 exhibiting a modeled gamma response to at least one of incident fast neutrons and high-energy photons is depicted. An x-axis 210 depicts an energy of the detected gamma rays and a y-axis 220 depicts a number of counts of gamma photons. For example, a spectrum of Fluorine (Fl) when activated by incident neutrons consists essentially of two gamma ray peaks 231, 232 at 6.1 MeV and at 7.1 MeV, respectively. The spectrum of SNM when excited by at least one of incident fast neutrons and high-energy photons is depicted as a plurality of gamma ray peaks 241. These results come directly from Monte Carlo models of the system, and represent an ideal spectrum, absent of any blurring of the signal in the detector 150 or through interaction with the cargo that may occur in practice.

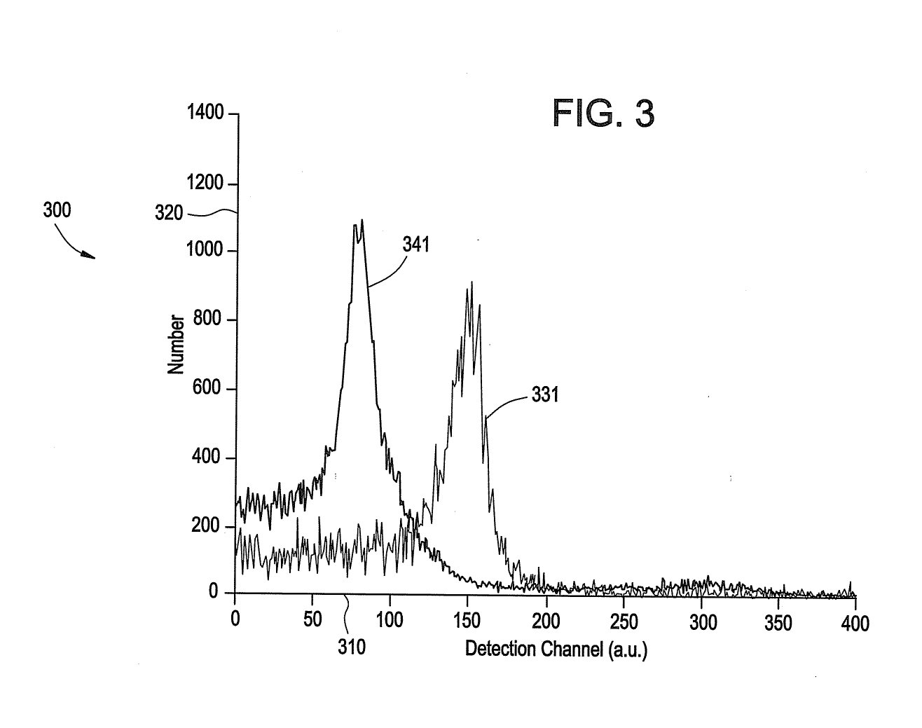

Referring now to FIG. 3, a chart 300 depicting an actual detected optical signal spectra exhibiting a gamma response to irradiation by at least one of incident fast neutrons and high-energy photons is depicted. An x-axis 310 depicts an energy (in arbitrary units) of the detected gamma rays and a y-axis 320 depicts a number of counts of detected gamma photons for that energy. A curve 331 depicts the Fl response and another curve 341 depicts the SNM response. From comparison of the spectra depicted by the curves 331, 341, it will be appreciated that the spectral information can be useful in discriminating SNM from the interferent Fl. Accordingly, in an embodiment, the detected spectral information will be compared by the processor 105 to the background signal to discriminate interferents from SNM, and thereby increase the accuracy of the SNM detection.

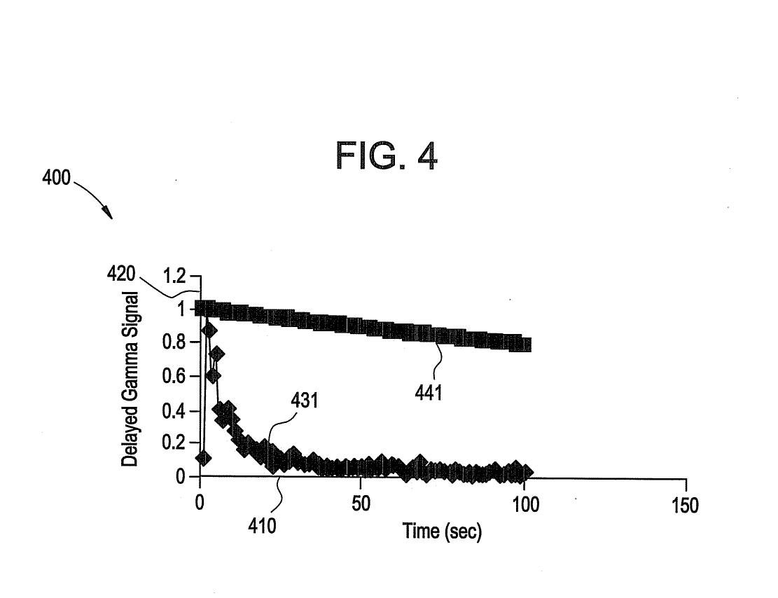

Referring now to FIG. 4, a time-response chart 400 of the emitted gamma signal in response to the irradiation is depicted. An x-axis 410 depicts an amount of time subsequent to the irradiation cycle in seconds, and a y-axis 420 depicts a normalized number of counts of gamma photons. A line of data points 431 indicates the decay response of SNM, and another line 441 indicates the decay response of Calcium (Ca), another known interferent. The half-life of the Ca decay 441 is 523 sec, which is much longer than that for the SNM decay 431. It will be appreciated that temporal response of the Ca interferent, like many other interferents, is different than the temporal response of SNM. Accordingly, in an embodiment, the temporal response will be compared by the processor 105 to analyze the second detector signal to discriminate interferents from SNM, and thereby increase the accuracy of the SNM detection.

Many interferents have a relatively low atomic number as compared to that of SNM, and the response to irradiation often includes only delayed gammas, and not delayed neutrons. In an embodiment, the SNM detection system 100 will detect delayed neutrons, and the processor 105 can use a lack of a neutron signature in interferents to further refine the discrimination analysis, and thereby increase the accuracy of the SNM detection.

In one embodiment, both the detection and discrimination decisions as well as the adaptively determining the operational parameters of each irradiation sequence, are based on decision trees with appropriate weights of various factors of interest determined in response to at least one of the initial screening and the primary inspection. These weights can be one of pre-defined and adaptive, or based on fuzzy set theory. Decision and operational parameter determination results can also be based on methods that will be appreciated by one skilled in the art, such as neural networks, for example. In an embodiment, a structure of the decision tree is an example of a multi-stage decision process selected to reduce the time needed for the detection process while maintaining a defined level of detection accuracy. In another embodiment, the decision process will include an expert system, or other suitable configurations known in the art.

In an embodiment, the processor 105 is receptive of information relating to histories of actual acquired cargo data including the detected signals, background data, and primary inspection results. The processor 105 is responsive to the information to update definitions of suitable features and at least one parameter of the detection and discrimination algorithm, to adaptively optimize system performance. For example, adaptive optimization can counteract performance and environmental drifts in the system and the background, and improve reliability and performance due to an increased resolution of data provided by use of an increasing number of datasets for determining the features and parameters.

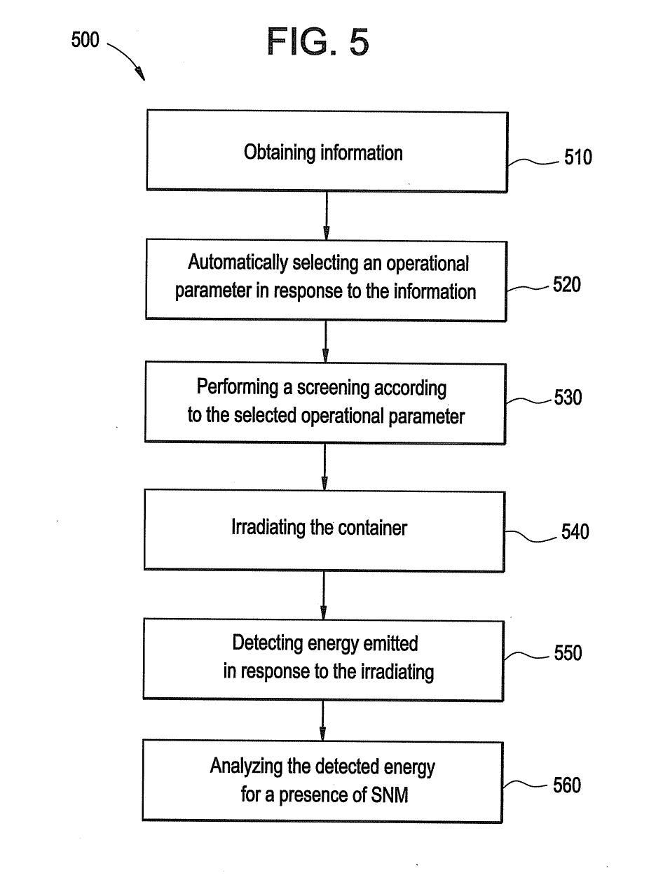

Referring now to FIG. 5, a flowchart 500 of process steps for determining a presence of SNM in a cargo container, such as the cargo container 175, by a SNM detection system, such as the SNM detection system 100, is depicted.

The method begins by obtaining at Step 510 information regarding at least one of the cargo container 175 and contents therein, automatically selecting at Step 520 the operational parameter in response to the information, and performing at Step 530 the screening of the container according to the selected operational parameter. The screening includes irradiating at Step 540 the cargo container 175 with the energetic beam comprising at least one of fast neutrons and high-energy photons, detecting at Step 550 energy emitted in response to the irradiating at Step 540 and analyzing at Step 560 the detected energy for a presence or absence of SNM within the cargo container 175.

In an embodiment, the obtaining at Step 510 includes obtaining information regarding a radiographic inspection, information regarding an inspection with portal monitors, information regarding handheld radiation monitors, information regarding a shipping manifest of the cargo container 175, information regarding at least one of a weight and a weight distribution of the cargo container 175, information regarding an origin of a shipping location of the cargo container 175, and information regarding a shipping company responsible for shipment of the cargo container 175.

In an embodiment, the performing at Step 530 the screening includes performing more than one screening and the obtaining at Step 510 includes information regarding the result of the analyzing at Step 560 a prior screening.

In an embodiment, the detecting at Step 550 includes detecting energy via the set of detectors 150, the set of detectors 150 including at least one of the neutron detector, the gamma ray detector, and the hybrid detector. The automatically selecting at Step 520 includes automatically selecting one or more detectors 150 of the set of detectors 150. In an embodiment, the detecting at Step 550 includes detecting gamma rays and neutrons.

In an embodiment, the automatically selecting at Step 520 includes selecting at least one of the duration of the irradiating at Step 540 and the duration of the detecting at Step 550. In another embodiment, the automatically selecting at Step 520 includes selecting as the energetic beam one of fast neutrons and high-energy photons. In another embodiment, the irradiating at Step 540 includes irradiating at a specified energy level and the automatically selecting at Step 520 includes selecting the specified energy level. the analyzing at Step 560 includes one of a determinate result to indicate the presence or absence of SNM within the cargo container 175, and an indeterminate result to indicate an inability to determine the presence or absence of SNM within the cargo container 175. In an embodiment, the analyzing at Step 560 includes comparing the set of characteristics of the detected energy signal with the corresponding expected set of characteristics to define the confidence level of the determinate result. In an embodiment, the analyzing at Step 560 includes analyzing the detected energy signal including at least one of detected spectral information, detected temporal information, and detected neutron information to discriminate SNM from an interferent.

In another embodiment, the analyzing at Step 560 includes comparing the detected energy to the threshold value. In an embodiment, the process includes updating the threshold value based upon the history of the detected energy signals. In an embodiment, the process includes manually selecting the operation parameter to override the automatically selecting at Step 520 the operational parameter. It will be appreciated that it may be desired to adjust the operation parameter that has been automatically selected, such as to increase the irradiation or detection time to gain an increased detail level, for example. In one embodiment, two or more suitable operational parameters for subsequent screening are presented to the operator, and the manually selecting includes selecting one of the presented suitable operational parameters.

An embodiment of the invention may be embodied in the form of computer-implemented processes and apparatuses for practicing those processes. Embodiments of the invention may also be embodied in the form of a computer program product having computer program code containing instructions embodied in tangible media, such as floppy diskettes, CD-ROMs, hard drives, USB (universal serial bus) drives, or any other computer readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to detect SNM and to adaptively modify the operation of the detection system to increase an accuracy of the detection of SNM.

As disclosed, some embodiments of the invention may include some of the following advantages: the ability to increase detection accuracy by adapting at least one of the irradiation sequence and the detection parameters in response to at least one of an initial screening and a primary inspection; the ability to use delayed neutron emission in response to irradiation to increase interferent discrimination accuracy; the ability to use energy spectral response to increase interferent discrimination accuracy; the ability to use temporal response to increase interferent discrimination accuracy; and the ability to adaptively update system operational parameters and detection thresholds in response to acquired data to improve detection accuracy.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed as new and desired to be protected by Letters Patent of the United States is:

1-14. (canceled)

15. A system for analyzing a presence of special nuclear materials (SNM) within a container, the system comprising:
a computer usable medium having computer readable program code;
a processor responsive to the computer program code executable thereon;
an energy source in signal communication with and responsive to the processor to emit fast neutrons; and
a set of energy detectors in signal communication and responsive to the processor to detect energy emitted in response to the emission of the fast neutrons;
wherein the processor, upon execution of the computer program code, is responsive to information regarding contents within the container to automatically adjust an operational parameter of the energy source and an operational parameter of the set of energy detectors, and to analyze energy detected by the set of energy detectors for a presence of SNM in response to an irradiation of the container by the energy source.

16. The system of claim 15, wherein
the information comprises information regarding a radiographic inspection.

17. The system of claim 15, wherein
the information comprises information regarding analysis of a prior screening by the energy source and the set of energy detectors of the container.

18. The system of claim 15, wherein:
the set of energy detectors comprises a set of gamma ray detectors;
the operational parameter of the set of energy detectors defines a variable number of gamma ray detectors of the set of gamma ray detectors; and
the defined variable number of gamma ray detectors are responsive to the automatic of the operational parameter to detect the energy emitted.

19. The system of claim 15, wherein:
the operational parameter of the energy source defines a duration of the emission of the fast neutrons; and
the energy source is responsive to the automatic adjustment of the operational parameter to emit fast neutrons for the defined duration.

20. (canceled)

21. The system of claim 15, wherein:
the operational parameter of the energy source defines an energy level of the fast neutrons; and
the energy source is responsive to the automatic adjustment of the operational parameter to emit fast neutrons at the defined energy level.

22. The system of claim 15, wherein
the processor, upon execution of the computer program code, analyzes the energy detected to provide a determinate result.

23. The system of claim 22, wherein
the processor, upon execution of the computer program code, compares a set of characteristics of the energy detected with an expected set of characteristics to define a confidence level of the determinate result.

24. The system of claim 15, wherein
the processor, upon execution or the computer program code, analyzes the energy detected comprising spectral information to discriminate SNM from an interferent.

25. The system of claim 15, wherein
the processor, upon execution of the computer program code, compares the energy detected to a threshold value to analyze the energy detected for the presence of SNM.

26. The system of claim 25, wherein
the processor, upon execution of the computer program code, is receptive of information relating to a history of energy detected, the processor responsive to update the threshold value based upon the information relating to the history.

27. The system of claim 15, wherein
the processor, upon execution of the computer program code, is responsive to the information to adaptively define the operational parameter.

28-37. (canceled)
